(19) United States
(12) Patent Application Publication
(10) Pub. No.: US 2011/0115265 A1
(43) Pub. Date: May 19, 2011

(54) Bicycle Saddle

(76) Inventors: Lutz Scheffer, Garmisch-Partenkirchen (DE); Andreas Heimerdinger, Loffenau (DE); Kim Tofaute, Koblenz (DE); Franc Arnold, Koblenz (DE)

(21) Appl. No.: 12/085,852

(22) PCT Filed: Nov. 30, 2006
(86) PCT No.: PCT/EP2006/069135

§ 371 Date: Nov. 1, 2010

(30) Foreign Application Priority Data
Dec. 1, 2005 (DE) 20 2005 018 851.1
Jun. 9, 2006 (DE) 20 2006 009 063.0

(51) Int. Cl. B62J 1/10

(52) U.S. Cl. 297/204

(57) ABSTRACT

A bicycle saddle, in particular a man's bicycle saddle, has a two-part saddle shell with a front part and a seat part. A saddle framework is connected to the bottom sides of the front part and the seat part. In order to adjust the hardness of the saddle, a variable spacer element is provided between the front part and the seat part to adjust the horizontal distance between the front part and the seat part.

### BACKGROUND

1. Field of the Disclosure

The disclosure pertains to a bicycle saddle, in particular to a man's bicycle saddle.

2. Discussion of the Background Art

Generally, bicycle saddles comprise a rear portion, a seat part, on which the cyclist sits. In the direction of travel the seat part changes into a narrow and elongated front part. Such bicycle saddles are detrimental in that the bicycle saddle exerts a pressure on the cyclist's genital region during cycling. This is uncomfortable especially for male cyclists and reduces the traveling comfort. Furthermore, there is a risk of permanent health problems in particular during prolonged bicycling.

A bicycle saddle comprising a two-part saddle shell wherein the front part of the saddle shell is hingedly connected to the seat part of the saddle shell has been known from DE 199 320 31 A1. Hence, the tip of the bicycle saddle or the front part thereof can fold down. However, such a saddle provides an insufficient relief of the genital region. Moreover, the bicycle saddle cannot be individually adjusted to the cyclist.

It is the object of the disclosure to provide a bicycle saddle wherein, on the one hand, the pressure existing in the genital region is reduced and, preferably in particular, the hardness of the saddle may be adjusted.

### SUMMARY

The bicycle saddle of the disclosure comprises a multipart, in particular two-part saddle shell having a front part and a seat part. A saddle framework is connected to a bottom side of the front part and/or seat part. Via an adapter, the saddle framework serves to attach the saddle to the saddle supporting tube. Usually, the saddle framework comprises two frame stays. According to the disclosure, a spacer element is arranged between the front part and the seat part of the saddle shell. To adjust a horizontal distance between the front part and the seat part, the spacer element is designed to be variable, in particular lengthwise adjustable. Thus, it is possible to increase the hardness of the saddle by decreasing the distance between the front part and the seat part. In this case the saddle framework is firmly connected to the front part and the seat part in the longitudinal direction of the saddle.

In particular, the bicycle saddle of the disclosure is a further development of the bicycle saddle described in the subsequently published utility model application DE 20 2004 013 746, the contents of said application being incorporated herein by reference in its entirety. A substantial element of the bicycle saddle described in said utility model application is an element for adjusting the height between the front part and the seat part of the bicycle saddle. The additional provision of an inventive spacer element which may be combined with the element for adjusting the height ensures the resilience of the front part to be adjusted very individually. In particularly preferred embodiments, the inventive spacer element is not combined with the height adjustment. Hence, only a single element for adjusting the hardness is provided.

The spacer element may be designed as a rigid element and may, e.g., comprise a screw or the like. If the spacer element has a higher stiffness than the saddle shells, a change of the position of the spacer element will always result in a change of the distance between the front part and the seat part of the at least two-part saddle shell. However, the spacer element may optionally be elastic which enables the hardness of the spacer element to be varied by adjusting the spacer element. In this case optionally no or only a slight horizontal change of the distance between the front and seat parts will occur. Nonetheless, due to the change of hardness or stiffness of the spacer element or at least one component of the spacer element the hardness thereof will vary. Preferably, the spacer element or at least one component of the spacer element is designed such that a change of length of the spacer element, that is, a change of stiffness of the spacer element, will be accompanied by a change of the distance between the front part and the seat part of the saddle shell.

Preferably, the spacer element comprises a first retaining part connected to the front part and a second retaining part connected to the seat part. In particularly preferred embodiments both retaining parts are interconnected by a connecting element with the connecting element preferably being designed to be lengthwise adjustable. Since both retaining parts are preferably firmly connected to the front part and the seat part, respectively, a lengthwise adjustment of the connecting element will result in an adjustment of the distance between the front part and the seat part. Here, the connecting element may be adapted to be a screw which is retained by one of both retaining parts and engages in a thread provided in another retaining part. Likewise, the connecting element may be designed as a suitable detent element. Here, the lengthwise adjustability is to be interpreted as a change of the distance of both retaining parts or the front part and the seat part caused by the connecting element. Moreover, it is possible to design not the connecting element as such but one or both of the connecting parts with the appropriate part of the saddle shell to be lengthwise adjustable with the position of the retaining part being fixable in various positions. Fixing may be accomplished by suitable detent elements, clamp connections and the like.

In this case the distance is adjustable such that the user can change the distance in a straightforward manner. With a connecting element designed as a screw or threaded rod, this may be performed by a suitable adjustment using a wrench. Also with the provision of detent elements a displacement may optionally be performed by hand or simple tools. In another embodiment a distance adjustment can be designed such that it may be accomplished, e.g., only by replacing the connecting element. Such a distance adjustment is an adjustment of a given distance the user will usually not, or only rarely, change.

In an especially preferred embodiment, the connecting element is inclined with respect to a saddle plane. Here, when the saddle is mounted, the saddle plane is the essentially horizontal top side of the saddle. Hence, when the saddle is mounted, the connecting element is inclined with respect to a horizontal plane. This is advantageous in that tensioning the connecting element, that is, changing the distance between both retaining elements will not only result in changing the horizontal distance between both saddle parts but also in a change of the vertical position of both saddle parts with respect to each other in the genital region. The connecting element or a central axis thereof is inclined with respect to the saddle plane or a horizontal plane preferably in a range of from 10 to 50°.

Preferably, the connecting element is inclined such that the front part of the saddle in the genital region is moved upwards if the connecting element is tensioned, that is, if the distance of the connecting elements relative to each other decreases. In this case the inclination of the connecting element is such that the connecting element extends downwards from the mounted front part. Hence, the vertical distance between the connecting element and the front part is smaller than the vertical distance between the connecting element and the seat part.

The connecting element may be designed as a screw or threaded rod but also as an elastic intermediate part such as an elastic rod or a cable.

In another embodiment the connecting element comprises a cable. In particular, the connecting element is designed as a cable and extends from one of both retaining elements to the second retaining element, said second retaining element comprising a deflecting element. Thus, the cable is routed back to the other retaining element after partially wrapping the deflecting element. In this case the deflecting element may be connected to the first or second retaining element. Hence, both ends of the connecting element designed as a cable are connected to the same retaining element. In particular the position of one of both ends with respect to the retaining element may be adjustable or variable to enable the length of the cable and thus the cable tension and/or distance between the front part and the seat part to be changed.

In another especially preferred embodiment the connecting element comprises a holding element. The holding element especially serves to hold at least one cable end. Hence, in this embodiment at least one cable end may be connected to the holding element, whereas the other cable end is connected to the first or second retaining element. In this embodiment both cable ends are preferably connected to the holding element wherein the cable wraps a deflecting element connected to one of both retaining elements or connects to said deflecting element. Preferably, the holding element is connected to one of both retaining elements such that the position of the holding element is variable and in particular longitudinally movable. In this case the holding element is connected to the retaining element preferably by an adjusting element which may be a threaded rod, an adjusting element comprising detent elements and the like. The position of the holding element is changed preferably in the longitudinal direction of the saddle by adjusting the adjusting element. This results in a change of the cable tension and/or distance between the front part and the seat part of the saddle.

Preferably a damping element is provided between the connecting element and one or both of the retaining elements. When using the saddle, this is advantageous in that a cushioning or damping effect is provided. This is especially advantageous when using the inventive saddle with mountain bikes in order to dampen any shocks.

Preferably, the damping element is designed such that it is replaceable in particular by the user him- or herself. This enables the use of damping elements of varying hardnesses and consequently varying damping characteristics. In particular, the damping element comprises several, individually replaceable disks. This enables the adjustment of a very individual hardness.

In order to enable also a vertical movement or inclination of the front part with respect to the seat part, the connecting element is hingedly and particularly pivotably connected to the first and/or second retaining part with the axis preferably being perpendicularly oriented to the longitudinal axis. The front part pivots or deforms preferably around an optionally virtual pivot axis located in the saddle tip region.

In a particularly preferred embodiment the spacer element comprises a handwheel which is in particular connected to the connecting element. In this case the connecting element preferably comprises a threaded rod which is connected to the handwheel. Hence, the hardness of the saddle may easily be changed by turning the handwheel. Due to the provision of a handwheel no tools are required for this adjustment.

Both in the embodiment lacking a handwheel where the adjustment is accomplished using tools and the embodiment comprising a handwheel the connecting element is preferably arranged such that it is easily accessible from the back of the saddle.

In order to provide an accessibility of the handwheel as good as possible, the front part comprises a bulge or lug protruding into the seat part. The bulge is adapted to be essentially U or V shaped. It is especially preferred that the lug protrudes into the seat part such that the bulge or lug protrudes between the fastening elements of the saddle framework provided on the seat side. This enables a good accessibility of the connecting element. In particular, the seat part has a recess corresponding to the bulge.

The front part and the seat part of the bicycle saddle may each comprise a separate padding element. In this case the padding element may also comprise a lining fixing the pad.

Moreover, it is possible to provide a common padding element. Hence, in this embodiment not the complete saddle but only the saddle shell is bipartite. The common padding element spans both the front part and the seat part of the saddle shell. Furthermore, due to the elasticity of the padding element the hardness of the saddle may be varied using the inventive spacer element.

In another preferred embodiment the front part comprises a stiffening element which is preferably longitudinally oriented, said stiffening element being adapted as the first retaining part of the spacer element. In this case it is especially preferred that the stiffening element stiffens a longitudinal slot in the front part. The longitudinal slot which is preferably continuous in the vertical direction serves as a vein channel. Especially preferably the stiffening element is designed to surround the longitudinal slot in a collar-like manner.

Another disclosure which is independent from the above-described embodiments is that a multipart, in particular two-part saddle, the front part and seat part of which are connected to a saddle framework, is designed such that the front part is resilient or elastically deformable. In this case a free end of the front part pointing towards the seat part is designed to be elastic. Preferably, the front part is connected to the framework only in the saddle tip area and has a stiffness providing resiliency to the front part of the saddle in the genital region in particular due to the pressure load resulting from the cyclist's weight. The stiffness or elasticity of the front part, especially of the saddle shell of the front part are matched to the envisaged loads. The free length of the front part, that is the cantilever length, and the cyclist's weight determine the material properties. This may be achieved by providing stiffening elements made from a hard material, saddle shells having varying thicknesses and/or allowances. Preferably, the elasticity or deformability of the free end of the front part is selected to enable the front part in the genital region to be lowered by 1-1.5 cm due to the common loads envisaged during cycling. In this case the front part may be configured, e.g., by providing optionally replaceable stiffening elements depending on the cyclist's weight.

In this embodiment a damping element or stop may be provided at the bottom side of the front part in the region adjacent to the saddle post in order to avoid a hard impact of the front part on the saddle post in the lowered or deflected state of the front part in extreme situations. Said stop may also be configured as an element connected to the saddle framework, e.g., a cross brace.

### BRIEF DESCRIPTION OF THE DRAWINGS

Hereinafter the disclosure will be illustrated in more detail by means of the attached drawings, wherein:

FIG. 1: is a schematic top view of a first embodiment of a bicycle saddle,

FIG. 2: is a schematic bottom view of the bicycle saddle illustrated in FIG. 1,

FIG. 3: is a schematic sectional view along the line III-III in FIG. 2,

FIG. 4: is a schematic bottom view of a second embodiment of the bicycle saddle,

FIG. 5: is a schematic rear view of the bicycle saddle illustrated in FIG. 3 in the direction of the arrow IV in FIG. 3,

FIG. 6: is a schematic bottom view of a third embodiment of the bicycle saddle,

FIG. 7: is a schematic bottom view of a fourth embodiment of the bicycle saddle,

FIG. 8: is a schematic sectional view in the longitudinal direction of a bicycle saddle representing an independent disclosure.

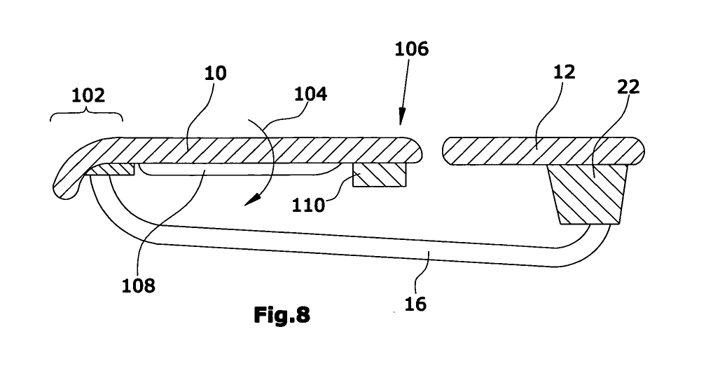

### DETAILED DESCRIPTION OF THE PREFERRED EMBODIMENT

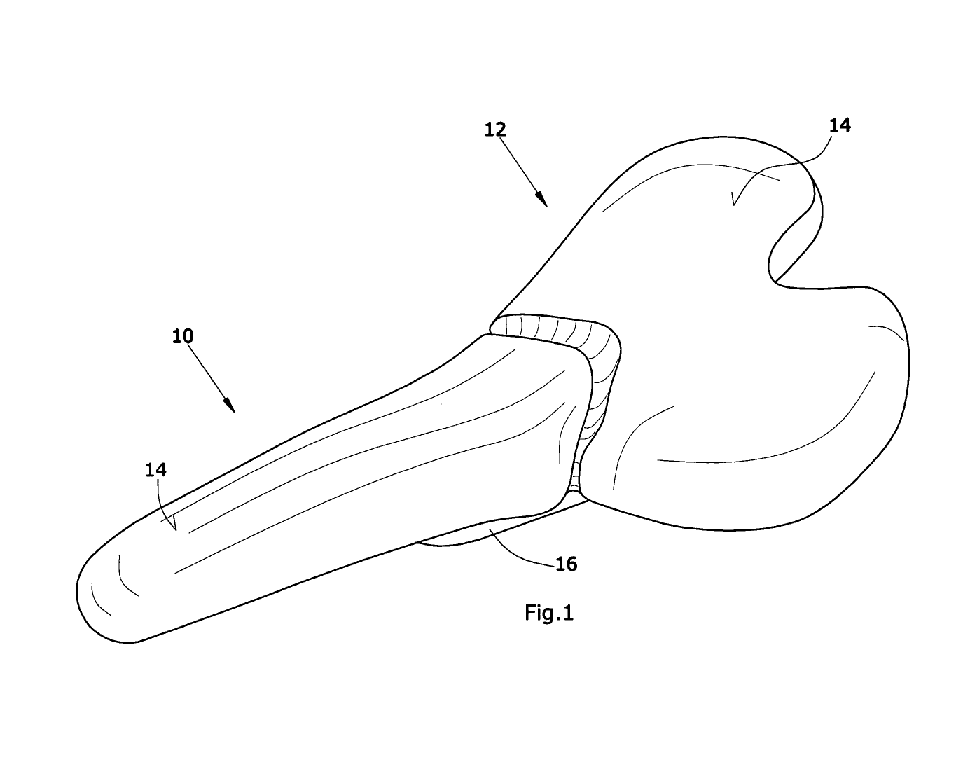

According to a first embodiment (FIGS. 1-3), the saddle has a two-part saddle shell comprising a front part 10 and a seat part 12. Both saddle shell parts 10, 12 are each provided with a padding element 14 wherein said padding element 14 may comprise a pad and a lining. Frame stays 16 of a saddle framework extending essentially in the longitudinal direction of the saddle are connected to the bottom sides of the front part and the seat part. At the bottom side of the front part 10 this is accomplished by a fastening or holding element 18 wherein both ends of the frame stays 16 are fixed. At the bottom side of the seat part 12, the opposing ends of the frame stays 16 are connected to the bottom side of the seat part 12 by a bridging element 20. In the illustrated embodiment, the bridging element is shown as the part which is bone-shaped in top view, said part being connected to the bottom side of the seat part 12 and made in particular from plastic. In a center region with respect to the width of the seat part, the bridging element 20 has a web-shaped connection 22.

An essential element of the disclosure is the spacer element 24 to adjust a horizontal distance between the front part 10 and the seat part 12 in order to adjust the hardness of the saddle. In the illustrated embodiment, the spacer element 24 has a first retaining part 26 which is firmly connected to the front part 10. The web part 22 serves as the second retaining part connected to the seat part 12. A connecting element 28 which is a screw element in the illustrated embodiment is provided between the first retaining part 26 and the second retaining part 22. Here, a thread of the screw element 28 engages into a threaded holding element 30, said holding element 30 being connected to the first retaining part 26. Moreover, at the opposite side the screw element 28 comprises a head part 32 which is supported by a side 34 of the second retaining part 22 facing away from the first retaining part 26. For this, the second retaining part 22 has a through bore 36. Hence, the distance between the front part and the seat part may be varied by turning the screw element 28 in order to adjust the hardness of the saddle. In the illustrated embodiment the screw element 28 at the back of the saddle may be actuated by a wrench such as an Allen key in the direction of arrow 38.

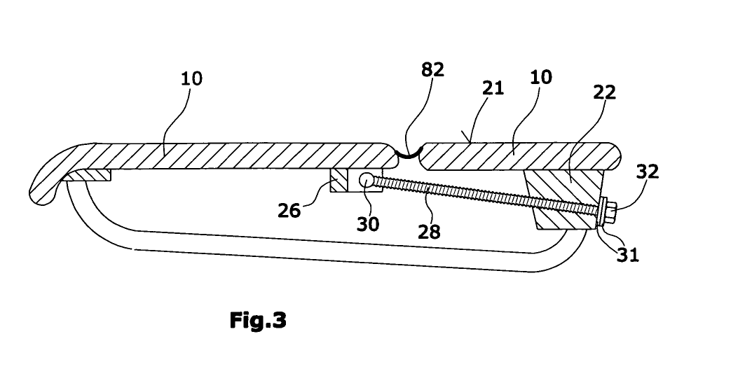

As can be learnt in particular from FIG. 3, in a preferred embodiment the connecting element 28 is inclined with respect to a saddle plane 21, that is, a plane which is essentially horizontal when the saddle is mounted. In particular, the distance from the connecting element 28 to the front part 10 is lower than the distance to the seat part 12 (FIG. 3). In this embodiment tensioning, that is, turning the head part 32 of the screw part 28 will result not only in a decrease of the distance between the front part 10 and the seat part 12 but also in a change of the vertical position of the front part 10 with respect to the seat part 12.

The angle of the screw element 28 preferably ranges from 10-55°. However, another embodiment may provide a connecting element 28 having a horizontal alignment.

In particular when designing the inventive saddle for mountain bikes, damping elements in the form of damping disks 31 are provided, e.g., between the retaining element 22 and the head part 32.

Since a two-part saddle shell is also particularly advantageous in that the front part 10 may be designed to be resilient in the genital region, that is in the region facing the seat part 12, the holding element 30 is hingedly, in particular pivotably connected to the first retaining part 26. For this, the holding element 30 is designed to be, e.g., cylindrical and pivotable around an axis 40. The cylindrical holding element 30 is inserted into the pivot axis 40 of concentric openings of two arms or web parts 42 of the first retaining part 26 facing each other. The holding element 30 has an internally threaded bore extending vertically to the pivot axis 40 which engages into the external thread of the screw element.

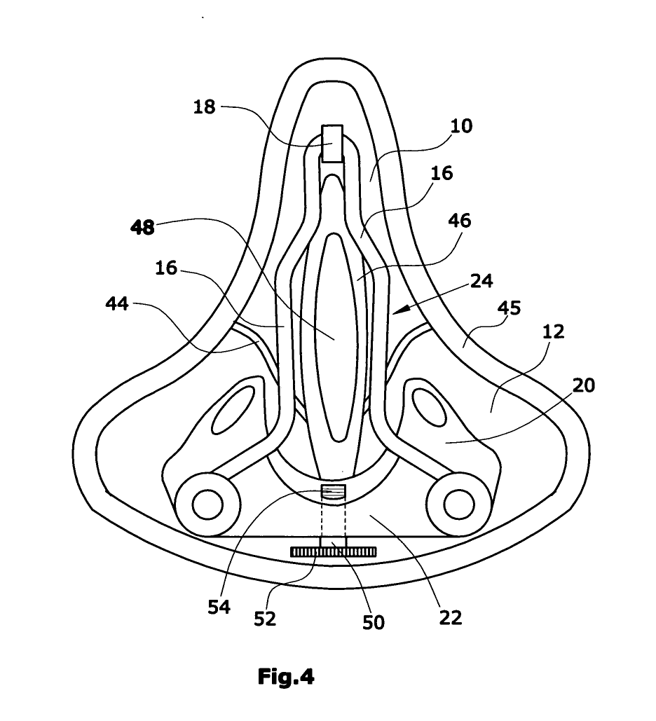

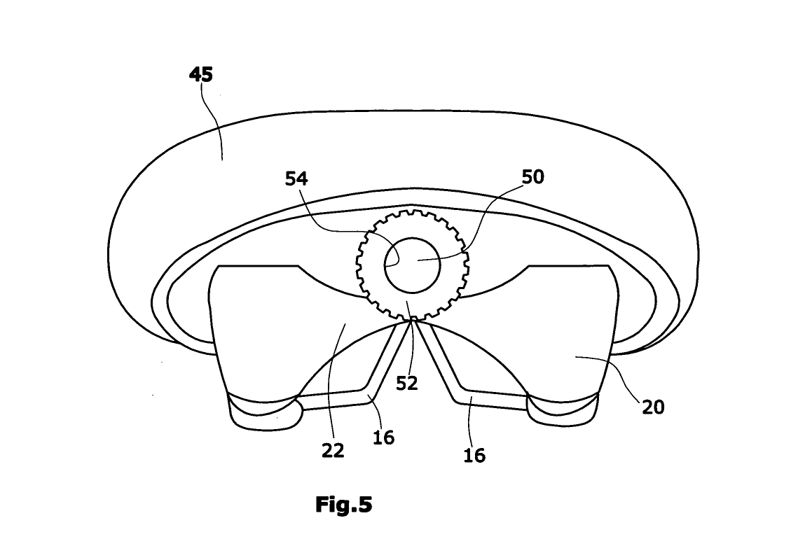

In a second embodiment (FIGS. 4 and 5) of the inventive saddle the same or similar components are labeled by the same reference numbers.

The saddle also comprises a two-part saddle shell with a front part 10 and a seat part 12. Between both of the saddle shell parts 10, 12 a slot 44 is provided. In the illustrated embodiment said slot is U shaped. At the saddle tip another fastening element 18 connects both frame stays 16 of the saddle framework to the bottom side of the front part 10. The frame stays 16 are connected to the bottom side of the seat part 12 also by a bridging element 20.

An essential difference between both embodiments is that the padding of both saddle shell parts 10, 12 is not accomplished by individual pads but a common padding element 45. Again preferably, the padding element 46 comprises a pad and a lining. The padding element comprises one part and spans both saddle shell parts 10, 12. Hence, the two-part constitution of the saddle shell can only be recognized from below (FIG. 4) as the slot 44 can be seen between both saddle shell parts.

Another difference between both embodiments is the design of the spacer element 24 which comprises a stiffening element 46 as the first retaining part in this embodiment . Like the first retaining element, said stiffening element 46 is firmly connected to the bottom side of the front part 10. In the illustrated embodiment, the stiffening element 46 is designed to be essentially ellipsoidal.

The stiffening element 46 surrounds a slot 48 in the front saddle part extending in the longitudinal direction of the saddle. The slot 48 serves as a vein channel and is continuous. The stiffening element 46 surrounds the slot 48 in a collar-like manner.

At the end 54 pointing towards the second retaining part 22, the stiffening element 46 has a thread 54. The thread 54 interacts with a screw element 50. The screw element 50 is connected to a handwheel 52 to be actuated by hand. The thread 50 may be an internal thread provided in a bore of the stiffening element 46 with the screw element 50 comprising a mating thread engaging into said thread. Likewise, the stiffening element 46 may have a cylindrical lug having an external thread. The screw element 50 comprises a mating bore or cylindrical opening having an internal thread. Hence, the hardness of the saddle may simply be adjusted by turning the handwheel 52.

Both embodiments may be combined with each other, too. In particular, the first embodiment (FIGS. 1-3) may comprise a vein channel with a stiffening element.

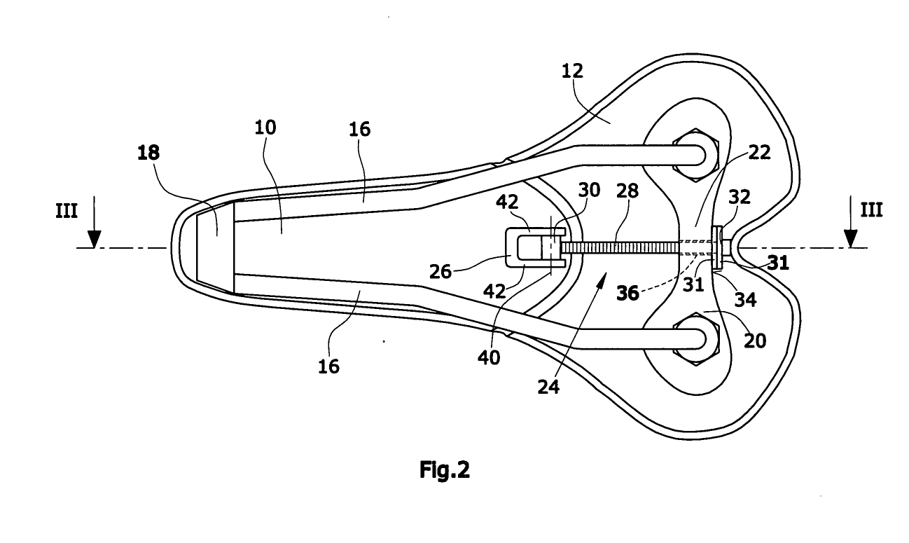

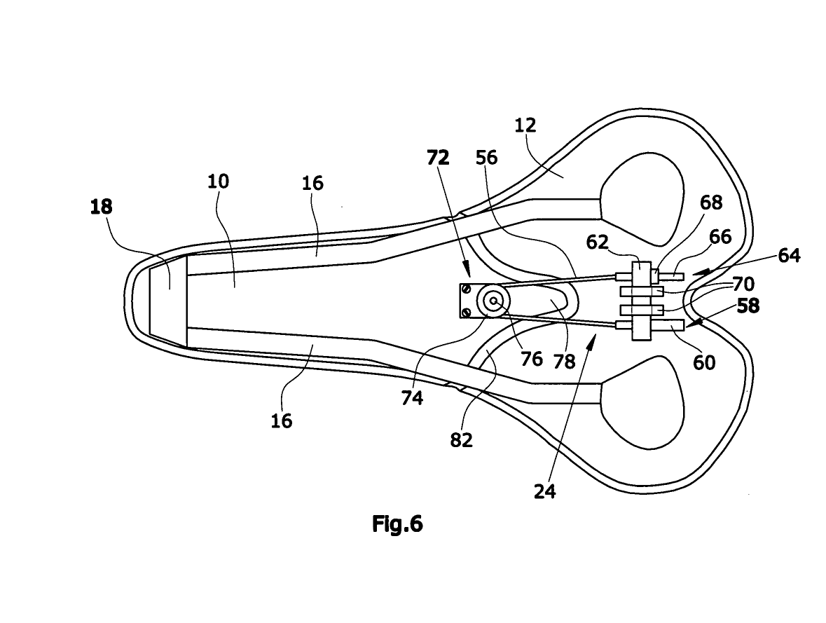

In a third preferred embodiment (FIG. 6) identical and similar parts are labeled by the same reference numbers. The essential difference between this embodiment and the embodiments described above by referring to FIGS. 1-3 is the design of the spacer element 24. The spacer element 24 comprises a cable 56. The cable 56 is firmly connected to an end 58 by a nipple or retaining part 60. Then, the cable is routed through an opening of a second retaining or fixing element 62 which is cylindrical in the illustrated embodiment. The second end 64 of the cable which is also connected to the fixing element 62 is connected to said element 62 by a thread element 66. A nut 68 is provided on the thread element 66. The effective length of the cable 56 which is in particular a steel cable may be varied by turning the nut 68. The fixing element 62 is indirectly or directly connected to the seat part 12 and consequently serves as a second retaining part. In this case the connection may be provided by lugs 70 firmly connected to the seat part 12. Likewise, the connection may be provided by a bridging element of the embodiment shown in FIG. 2.

A first retaining part 72 is again firmly connected to the front part 10 of the saddle and comprises a deflecting element 74 in the illustrated embodiment. The deflecting element 74 is, e.g., a metal, in particular an aluminium sleeve 76 or a roll rotatably supported by a bearing 56.

The front part 10 has a recess 78 protruding into the seat part 12. Thereby an essentially S shaped slot 80 is provided between the front part 10 and the seat part 12. Optionally, the slot 80 may be bridged by an elastic connecting element 82 (FIG. 3). Moreover, the elastic connecting element 82 permits the front part 10 to be lowered in the region of the recess 78 with respect to the seat part 12, but also restricts said lowering and hence serves as a confining element. The recess 78 is designed to abut the genital region in the normal seating position. This enables to reduce the extremely unpleasant pressure loads occurring in this region.

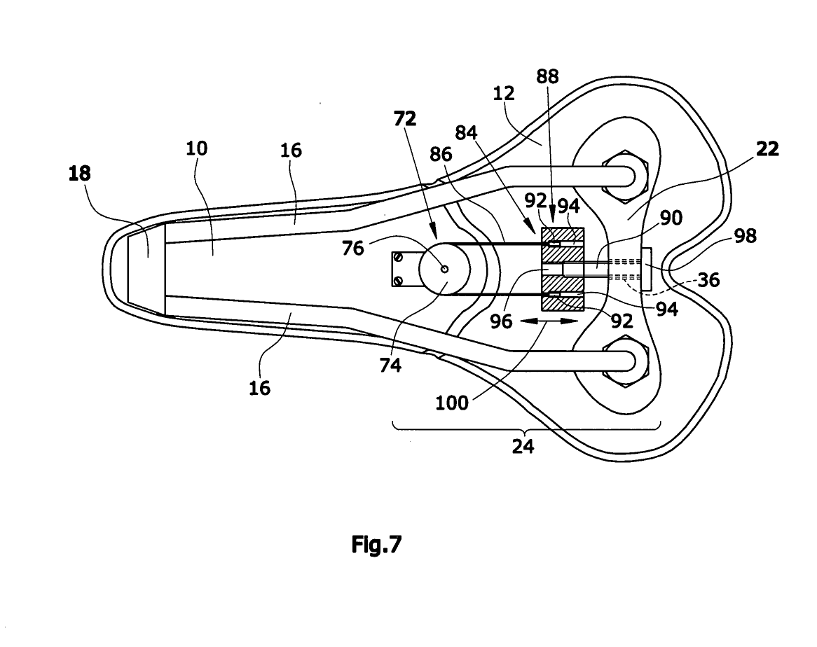

The embodiment illustrated in FIG. 7 is a further development of the embodiment illustrated in FIG. 6 or an alternative thereof. Hence, similar or identical components are labeled by the same reference numbers.

In the embodiment illustrated in FIG. 7, the spacer element 24 comprises a connecting element 84 in addition to both retaining elements 72, 22. In the illustrated embodiment, the connecting element 84 comprises a cable 86, a holding element 88 and an adjusting element 90 which is designed as a screw in the illustrated embodiment. At both ends the cable 86 comprises thickened portions or nipples 92, respectively. Both thickened portions 92 are located in recesses 94 of the holding element 88 with both recesses 94 being designed such that the thickened portions 92 cannot be pulled leftwards in FIG. 7, hence, out of the holding element 88. According to the embodiment illustrated in FIG. 6, the cable 86 wraps a deflecting element 74.

Moreover, the holding element comprises a threaded central opening or bore 96 into which the adjusting element 90 designed as a screw may be screwed. According to the embodiment illustrated in FIG. 2, the screw 90 is passed through a through bore 36 of the second retaining part 22 or bridging element such that a screw head 98 is arranged at the side of the second retaining element 22 facing away from the holding element 88. Hence, the retaining or bridging element 22 is a counter bearing. By turning the screw 90, the position of the holding element 88 changes in the direction of the arrow 100. This results on the one hand in a tensioning or slackening of the cable 86 and on the other hand in a change of the distance between the front part 10 and the seat part 12.

In another independent disclosure a bicycle saddle also comprises a multipart saddle shell. In particular, the saddle shell is bipartite and comprises a front part 10 and a seat part 12. Both shell parts 10, 12 are interconnected by a saddle framework 16. A rear end of the saddle framework 16 is connected to the saddle shell 12 by a bridging element 22. Preferably, the components 10, 12, 16, 22 are configured according to the above-mentioned embodiments.

The saddle framework 16 is firmly connected to the front part 10 in the area of a saddle tip 102. The front part is designed to be elastic or deformable and may consequently be tilted or deformed from the shown position in the direction of an arrow 104. On the application of suitable forces a free end 106 will be pressed downwards. This results in a reduction of the pressure loads acting on the genital region of a cyclist. Here, the elasticity of the front part 10 may be adapted to the user's weight, the intended use etc. Thereto, optionally replaceable stiffening elements 108 provided at a bottom side of the front part 10 may be provided. For instance, stiffening elements 108 having various hardnesses may be provided to adjust the elasticity of the front part 10.

In order to avoid damages of the bottom side of the front part 10 by an impact on the saddle post during extreme deflections of the front part 10 in the direction of the arrow 104, a damping element 110 is provided at the bottom side of the front part 10.

What is claimed is:

1. A bicycle saddle, in particular a man's bicycle saddle comprising
a multipart, in particular two-part saddle shell having a front part and a seat part; and
a saddle framework connected to a bottom side of the front part and/or a bottom side of the seat part,
wherein a variable spacer element to adjust the horizontal distance between the front part and the seat part in order to adjust the hardness of the saddle.

2. The bicycle saddle according to claim 1, wherein the spacer element comprises a first retaining element connected to the front part and a second retaining element connected to the seat part.

3. The bicycle saddle according to claim 2, wherein the retaining elements are interconnected by a connecting element to adjust the lengthwise distance.

4. The bicycle saddle according to claim 3, wherein the connecting element is hingedly connected to the first retaining element and/or the second retaining element.

5. The bicycle saddle according to any of claim 2, wherein the saddle framework is connected to the second retaining element and the second retaining element is in particular adapted to be a bridging element.

6. The bicycle saddle according to any of claim 3, further comprising a damping element is provided between the connecting element and one of both retaining elements.

7. The bicycle saddle according to claim 6, wherein the damping element has several disks which are in particular replaceable.

8. The bicycle saddle according to any of claim 3, wherein the connecting element is inclined with respect to a saddle plane.

9. The bicycle saddle according to claim 8, wherein the connecting element is inclined such that the front part moves up in the genital region if the connecting element is tensioned.

10. The bicycle saddle according to claim 8, wherein the inclination of the connecting element is such that the connecting element has a smaller distance to the front part than to the genital region.

11. The bicycle saddle according to claim 3, wherein the connecting element has a cable and both retaining elements comprises a deflecting element to deflect the cable.

12. The bicycle saddle according to claim 11, wherein the connecting element comprises a holding element to hold at least one, in a defined position.

13. The bicycle saddle according to claim 12, wherein the holding element is connected to the second holding element by an adjusting element.

14. The bicycle saddle according to claim 1, wherein the spacer element comprises a handwheel connected in particular to the connecting element.

15. The bicycle saddle according to claim 1, wherein the front part and the saddle part each comprise separate padding elements.

16. The bicycle saddle according to claim 1, wherein the front part and the saddle part comprise a common padding element.

17. The bicycle saddle according to claim 1, wherein the front part comprises a bulge protruding into the seat part.

18. The bicycle saddle according to claim 17, wherein the bulge essentially protrudes between the fastening elements of the saddle framework facing the seat part.

19. The bicycle saddle according to claim 1, wherein the front part is connected to a stiffening element which is in particular designed as the first retaining element.

20. The bicycle saddle according to claim 19, wherein the stiffening element surrounds a longitudinal slot provided in the front part in particular in a collar-like manner.
